(19) United States
(12) Patent Application Publication
(10) Pub. No.: US 2017/0146103 A1
(43) Pub. Date: May 25, 2017

(54) Slider Driving Mechanism on a CNC Assembly Machine for Assembled Camshaft

(71) Applicants: Changchun Jiyanghuaxin Science and Technology Co. Ltd., Changchun (CN); JILIN UNIVERSITY, Changchu (CN)

(72) Inventors: Shenhua Yang, Changchun (CN); Chunping Deng, Changchun (CN); Lei Yang, Changchun (CN); Shuqing Kou, Changchun (CN); Yong Zhao, Changchun (CN); Baojun Lin, Changchun (CN)

(21) Appl. No.: 14/945,743

(22) Filed: Nov. 19, 2015

(30) Foreign Application Priority Data
Nov. 19, 2015 (CN) 104476184A

(51) Int. Cl. F16H 25/22; B23P 19/04

(52) U.S. Cl. CPC F16H 25/2204; B23P 19/042; B23P 2700/02; F16H 2025/204

(57) ABSTRACT

The present invention relates to a slider driving mechanism on a CNC assembly machine for assembled camshaft. The mechanism includes a servo motor (1), the host frame (5), ball screw (6), linear guides (9) and the slider body (8), wherein, the servo motor (1), ball screw (6) and linear guides (9) are mounted vertically on the host frame (5). The servo motor (1) connects with the ball screw. The slider body (8) connects with both the ball screw (6) and the linear guides (9). It is driven by a ball screw (6) and moves along a linear guides (9) in the vertical direction. The present invention is novel. It not only can greatly improve the assembly speed of cam, hexahedron on assembled camshaft and improve productivity, but also can eliminate complex gear system. It makes the manufacturing and processing more simple. The installation is also more convenient. It can further improve product quality and manufacturing precision of assembled camshaft.

### TECHNOLOGICAL AREA

The present invention is applicable to engine assembled camshaft automated assembly equipment. It is a slider driving mechanism on a CNC assembly machine for assembled camshaft.

### BACKGROUND TECHNOLOGY

The assembled camshaft of engine is novel, operating economy, breaking the limitations of traditional camshaft material design and manufacturing philosophy. Light weight, low cost, high dimensional accuracy and material selection can be optimized. The camshaft profile can fit any job. So it can save processing step of camshaft profile and have other prominent features. The assembled camshaft is a new techniques and technology in which the cam, hexahedron and end are manufactured separately and then assembled one by one. It is an essential revolution for the traditional design and manufacturing technology in which camshafts are of one piece casting or forging and then of being machined. It can contribute to reducing vehicle costs and engine weight and improve engine performance.

The manufacturing process method or special equipment presented in the past patent about assembling camshaft were focused on thermal sleeve connection method and related equipment, welding connection method and related equipment, machinery bulging connection methods and related equipment, knurled connection method and related equipment. The shaft clamp and rotation mechanism are mounted on the knurled connection automated assembly machine. The slider driving mode of implementing press-fit are mainly servo motor and gearbox drive system and hydraulic servo drive system.

There are basically two kinds of slider drive mechanism. One is that a servo motor drives ball screw nut mounted on the frame to rotate through output shaft gear of a gear transmission. Moreover, it drives ball screw connected with a slider to move up and down in the Z-axis direction. Namely it drives the slider for vertical movement. Another is hydraulic servo drive mechanism. A piston having a long stroke in hydraulic servo cylinder mounted above the host frame drives a slider to move on the vertical direction. The assembled camshaft is made of shaft, cam, hexahedron, end which are separately manufactured by using different materials, different manufacturing process. These parts are assembled one by one to become a complete camshaft according to the drawings. The slider mechanism on camshaft assembly machine is the most critical institution, on which a shaft clamp mechanism driven by a hydraulic cylinder and shaft rotation mechanism driven by a servo motor are mounted. Before the camshaft is being assembled, hydraulic chuck will grip the shaft firstly. The shaft rotation mechanism driven by servo motor allows the shaft to complete the rotary motion of hobbing in the shaft surface according to the preparing process and achieve the rotary positioning of press-fit phase angle of each cam. The assembled camshaft has many separate parts. To improve production efficiency, the slider needs to run faster in idle stroke. While the slider needs to run slowly in working stroke. In the mode of servo motor driving gear transmission to make the slider move, the structure is complicated, manufacturing precision error is big, it is difficult to achieve high-speed operation. In the mode of the hydraulic servo drive, there are the high cost. It runs slowly. The axial assembly accuracy of camshaft is bad.

### DISCLOSURE

The technical problem to be solved is the one about slider driving mechanism on a CNC assembly machine for assembled camshaft at home and abroad. The inventor proposed a kind of slider driving mechanism on a CNC assembly machine for assembled camshaft based on the present invention patents CN1230273C.

In order to solve the above problem, the present invention proposed the following technical solutions:

A kind of slider driving mechanism on a CNC assembly machine for assembled camshaft includes a servo motor (1), the host frame (5), ball screw (6), linear guides (9) and the slider body (8), wherein, the servo motor (1), ball screw (6) and linear guides (9) are mounted vertically on the host frame (5). The servo motor (1) connects with the ball screw. The slider body (8) connects with both the ball screw (6) and the linear guides (9). It is driven by a ball screw (6) and moves along a linear guides (9) in the vertical direction.

Further, a pair of servo motors 1 are mounted on the host frame 5 through the servo motor support base 2. And they are directly connected with the ball screw 6 by a connecting sleeve 3. It can realize synchronous direct drive.

Further, the ball screw 6 is mounted on the host frame 5 and supported by the bearing sleeve 4 and the bearing 10. And it is connected with the slider body 8 via a ball screw nut 7.

There is a slider on the linear guide 9. The slider body 8 is mounted on the linear guide 9 by this slider.

The beneficial effects of the present invention are as follows:

In view of the above technical problems of slider driving mechanism, the present invention proposed a novel structure. Namely a servo motor directly drives the ball screw. The ball screw nut connects with the slider body. Driven by the servo motor, ball screw nut drives slider body to move quickly and accurately in a vertical direction. It not only can greatly improve the assembly speed of the parts of cam, hexahedron and end, improve productivity, but also can eliminate the complex gear system with high prices. It makes the manufacturing process more simple. The installation is more convenient. At the same time, it can further improve manufacturing precision and products quality of assembled camshaft.

### DESCRIPTION OF ACCOMPANYING DRAWINGS

FIG. 1. The product sketch of assembled camshaft

FIG. 2. The sketch of CNC assembly machine host for assembled camshaft

FIG. 3. The local sketch of shaft rotation mechanism of CNC assembly machine for assembled camshaft

FIG. 4. The sketch of shaft hobbing mechanism

In the figure:

1—servo motor, 2—servo motor support base, 3—connecting sleeve, 4—bearing sleeve, 5—host frame, 6—ball screw, 7—ball screw nut, 8—slider body, 9—linear guides, 10—bearing, 11—rotary disk support body, 12—rotary table base, 13—the clamping cylinder, 14—guide sleeve, 15—pull rod, 16—transmission shaft, 17—clamping mechanism block, 18—gear box, 19—driven gear, 20—rim, 21—spacer shim, 22—the lands, 23—hollow chuck, 24—claws, 25—shaft, 26—servo motors, 27—connection sets, 28—transmission shaft, 29—drive gear, 30—hobbing cylinder, 31—hobbing plate, 32—knurled knife, 33—rotary feeding plate, 34—positioning fixture block, 35—positioning fixture movable block, 36—feeding cylinder, 37—NC rotary table, 38—parts of cam, hexahedron

### DESCRIPTION OF THE PREFERRED EMBODIMENT

Following the present invention is the embodiment in conjunction with the accompanying drawings in a step for further description:

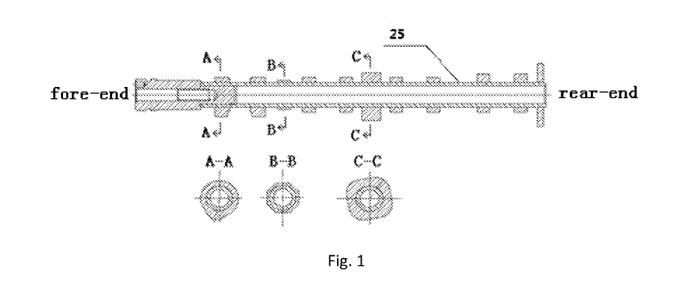

As shown in FIG. 1, the product structure sketch of assembled camshaft.

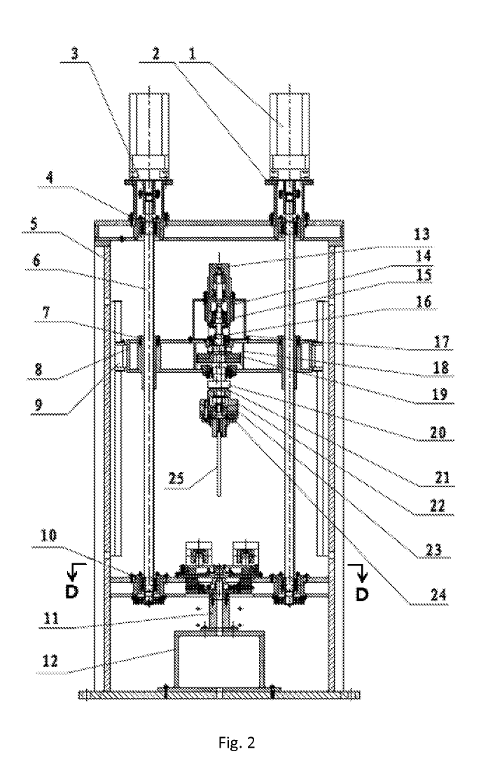

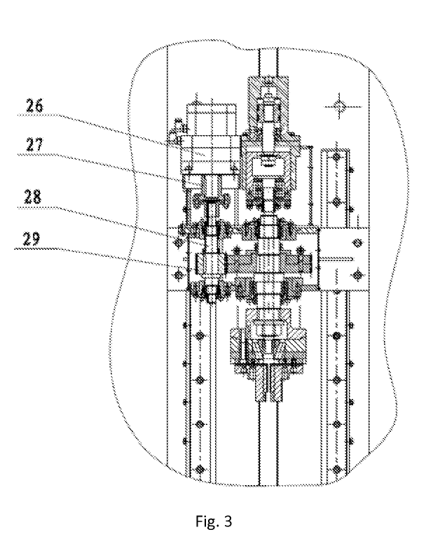

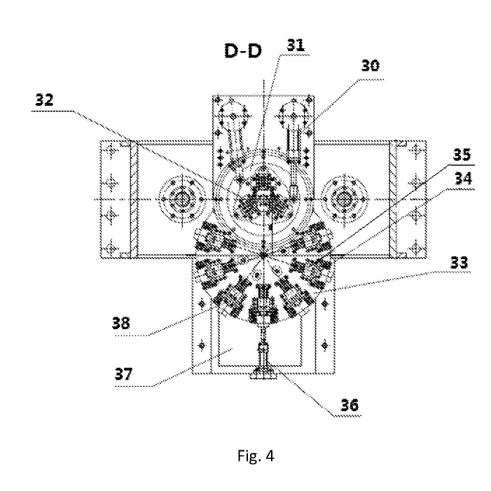

Referring to FIG. 2, FIG. 3, FIG. 4, a slider driving mechanism on a CNC assembly machine for assembled camshaft. It is composed as follows, servo motor 1, the ball screw 6 and linear guides 9 are mounted on the host frame 5, wherein, two servo motors 1 are mounted on the host frame 5 separately by the servo motor support base 2. And they are directly connected with the ball screw 6 by connecting sleeve 3. The ball screw 6 is supported by the bearing sleeve 4 and bearing 10 and is mounted on the host frame 5. The linear guides 9 is installed on the host frame 5 by bolts or other fasteners.

The ball screw nut 7 is mounted on the slider body 8 in order to achieve the movement of slider body 8 driven by ball screw 6. There is a slider on linear guide 9. The slider body 8 is mounted on the slide by linear guide 9. So the slider body 8 can do linear motion along the linear guides 9 driven by the ball screw 6.

In addition, in order to express specific embodiment of the invention more clearly, several key components on CNC assembly machine for assembled camshaft will be described briefly:

The shaft clamping device composed by clamping cylinder 13, guide sleeve 14, pull rod 15, transmission shaft 16, clamping mechanism block 17, gear box 18, driven gear 19, rim 20, spacer shim 21, the lands 22, hollow chuck 23, claws 24 is mounted on the slider body 8;

The shaft rotation mechanism composed by servo motors 26, connection sets 27, transmission shaft 28, drive gear 29, the driven gear 19, the transmission shaft 16 and gear box 18 is also mounted on the slider body 8;

The hobbing mechanism composed by hobbing cylinder 30, hobbing plate 31, knurled knife 32 is mounted on the host frame 5;

The automatic rotary feeding device composed by rotary feeding plate 33, positioning fixture block 34, positioning fixture movable block 35, feeding cylinder 36, NC rotary table 37 and rotary disk support body 11 is mounted on a rotary table base 12.

Referring to FIG. 2, FIG. 3, FIG. 4, the present invention is applied to CNC assembly assembled camshaft, performing the following steps:

a. manually or using robots put shaft 25 into the chuck 23, the claws 24 clamps the shaft 25. The parts of cam, hexahedron 38 are placed on rotary feeding plate 33. Positioning fixture block 34 and positioning fixture movable block 35 clamp these parts. In addition, the NC rotary table 37 sends the parts of cam, hexahedron 38 to the press-fit center position of host.

b. NC program, two servo motors 1 drive two ball screws 6 synchronously in forward direction and make them rotate. It makes slider body 8 move downward rapidly. When the shaft 25 reaches the hobbing predetermined position, surface of the shaft 25 is knurled. After hobing, the slider body 8 continues down and press the first cam on rotary feeding plate 33 into the hobbing position of shaft 25. Then the two servo motors 1 drive the slider body 8 synchronously in reverse direction to move upward rapidly to the initial position. Thus, the first cam is mounted on the shaft. According to the above process, press the other parts of cam, hexahedron and end 38 into the shaft 25 one by one in accordance with NC program compiled.

c. After the assembled camshaft is completed in the CNC assembly machines, manually or using robots remove the assembled camshaft, thus completing a cycle of work.

1. A slider driving mechanism on a CNC assembly machine for assembled camshaft, wherein: the slider driving mechanism includes a servo motor (1), the host frame (5), ball screw (6), linear guides (9) and the slider body (8), wherein, the servo motor (1), ball screw (6) and linear guides (9) are mounted vertically on the host frame (5). The servo motor (1) connects with the ball screw. The slider body (8) connects with both the ball screw (6) and the linear guides (9). It is driven by a ball screw (6) and moves along a linear guides (9) in the vertical direction.

2. According to claim 1, a slider driving mechanism on a CNC assembly machine for assembled camshaft, wherein: there are two servo motor (2) which are mounted on the host frame (5) by a servo motor support base. They are directly connected with two ball screws (6) by connection set (3) separately. In the end, it can directly drive synchronized synchronously.

3. According to claim 1 or 2, a slider driving mechanism on a CNC assembly machine for assembled camshaft, wherein: the ball screw (6) is supported by the bearing housing (4) and the bearing (10) and mounted on the host frame (5). And it is connected with slider body (8) via a ball screw nut (7).

4. According to claim 1 or 2, a slider driving mechanism on a CNC assembly machine for assembled camshaft, wherein: there is a slider on the linear guides (9). The slider body (8) is mounted on the linear guides (9) via the slide.
